(19) United States
(12) Patent Application Publication
(10) Pub. No.: US 2011/0189588 A1
(43) Pub. Date: Aug. 4, 2011

(54) SOLID OXIDE FUEL CELL AND BRAZING METHOD BETWEEN CELL AND CAP

(75) Inventors: Young-Kee Kim, Yongin-Si (KR); Jun-Won Suh, Yongin-Si (KR)

(73) Assignee: Samsung SDI Co., Ltd., Yongin-Si (KR)

(21) Appl. No.: 12/884,741

(22) Filed: Sep. 17, 2010

(30) Foreign Application Priority Data
Jan. 29, 2010 (KR) 10-2010-0008538

(51) Int. Cl. H01M 8/10

(52) U.S. Cl. 429/495

(57) ABSTRACT

A solid oxide fuel cell and a brazing method between a cell and a cap of a fuel cell capable of simplifying a brazing process relative to the related art are disclosed. Thus, improved production efficiency and an air seal while saving on the amount of filler metal used is achieved, by improving the structure of the sealing cap combined with the end of the cell. The solid oxide fuel cell includes a hollow tube type cell and a sealing cap combined with the end of the cell, the cap has a structure in which a passage tube which is in contact with a hollow portion of the cell is provided in the center of the cap and a combination tube combined with the cell end is integrally provided on the circumference of the passage tube to form a cell insertion space between the passage tube and the combination tube, and a brazing surface formed on the bottom of the cell insertion space and a filler metal diffusion space formed at the side of the brazing surface.

### CROSS-REFERENCE TO RELATED APPLICATIONS

This application claims priority to and the benefit of Korean Patent Application No. 10-2010-0008538, filed on Jan. 29, 2010, in the Korean Intellectual Property Office, the entire content of which is incorporated herein by reference.

### BACKGROUND

1. Field of the Disclosure

The present disclosure relates to a technology capable of saving a brazing process time and an amount of filler metal and improving an air seal in comparison with the related art by improving a cap structure of a solid oxide fuel cell and improving a brazing location and a brazing pattern between a cap and a cell.

2. Description of the Related Art

A fuel cell is a cell that converts chemical energy generated by oxidation into electric energy. The fuel cell is an environment-friendly power generation technology that generates electrical energy from abundantly existing materials on Earth, such as hydrogen and oxygen.

While an electrochemical reaction of a reverse reaction pattern to water electrolysis is in progress, by supplying the oxygen to a cathode of the fuel cell and fuel gas to an anode of the fuel cell, electricity, heat, and water are generated. Therefore, the generated electricity does not create pollution.

The electricity generating process is briefly described as follows. Hydrogen is supplied to the anode and the supplied hydrogen is decomposed into hydrogen ions and electrons. In addition, the hydrogen ions move to the cathode through an electrolyte membrane and the electrons move to the cathode through an external wire to generate electrical power.

Therefore, in the fuel cell, since a material discharged during the electricity generating process is mainly water, there is no concern for pollution and power generation efficiency is improved by approximately 40% or more in comparison with the related art. Furthermore, since mechanical moving parts are not required in the generation of electricity unlike a general heat engine, miniaturization of the device is possible and the generation of noise is minimized.

The fuel cell is generally classified into an alkaline fuel cell (AFC), a phosphoric acid fuel cell (PAFC), a molten carbonate fuel cell (MCFC), a polymer electrolyte membrane fuel cell (PEMFC), and a solid oxide fuel cell (SOFC) according to an electrolyte type.

Among them, the solid oxide fuel cell is widely being used since it is easy to control the position of the electrolyte and there is no concern of exhaustion of the electrolyte, and the life-span of a material is long. The solid oxide fuel cell is largely classified into a tube type and a flat type according to a unit cell type. As the tube type, an anode support type fuel cell using the anode as a support is principally being used and researched and developed.

A unit cell of the general tube-type solid oxide fuel cell has a structure in which an electrolyte layer 200 and an anode 300 are sequentially laminated on the outer surface of a cylindrical cathode 100 as shown in FIG. 1. In addition, an additional cap 400 for preventing supplied hydrogen gas from being mixed with outside air is combined with ends of the cathode 100 and the electrolyte layer 200 (hereinafter, a combination structure of the anode and the electrolyte layer is referred to as ‘cell 1’).

The end of the cell 1 fits in a cell insertion space 430 of the cap 400, and brazing B is performed between an outer peripheral surface 1a of the end of the cell 1 and the cell insertion space 430 and an end surface 1b of the cell 1 and the bottom of the cell insertion space 430, thereby improving the fixation and sealing of the cap 400 to the cell 1.

However, since the cell 1 is of a ceramic material such as Y₂0₃-stabilized Zro₂ (YSZ), while the cap 400 is of a general metallic material, the brazing process of the fuel cell is difficult to perform due to heterogeneity therebetween.

Moreover, this cell has a wetting problem which is an important condition of the brazing process, the brazing efficiency is deteriorated. Therefore, as shown in FIG. 1, only both portions of the outer peripheral surface 1a of the end of the cell 1 and the end surface 1b of the cell 1 are brazed. As a result, the brazing process should be further complicated and in addition, high-level technological power is required and consumption of filler metal increases.

Further, as described above, since the brazing is performed while the filler metal is interposed between the outer peripheral surface 1a of the end of the cell 1 and the cap 400, the filler metal is frequently sintered and overflows outside the cap 400. This phenomenon deteriorates the air seal. Therefore, improvement of the cap 400 is required.

In addition, a gap formed between the cell and the cap is widened in order to ensure a space for the filler metal, however as a result, a size of the cap increases.

### SUMMARY OF CERTAIN INVENTIVE ASPECTS

Some embodiments provide a solid oxide fuel cell capable of simplifying a brazing process, saving the amount of used filler metal, and implementing an improved air seal in comparison with the related art. This is achieved by improving a brazing position and a brazing pattern by improving a cap structure.

According to an aspect of the present disclosure, a solid oxide fuel cell basically includes a hollow tube type cell and a sealing cap combined with the end of the cell, wherein the cap has a structure in which a passage tube which is in communication with a hollow portion of the cell is provided in the center of the cap and a combination tube combined with the cell end is integrally provided on the circumference of the passage tube to form a cell insertion space between the passage tube and the combination tube, and a brazing surface to which an end surface of the cell is formed on the bottom of the cell insertion space and a filler metal diffusion space is further formed at the side of the brazing surface.

In addition, the filler metal provided between the brazing surface and the cell end surface is melted by heating the filler metal and the melted filler metal diffuses in the filler metal diffusion space.

Further, a minute gap leading to the diffusion space is formed between an outer peripheral surface of the unit cell and the cell insertion space of the cap and the filler metal also fills in the minute gap when heated.

In addition, the diffusion space is formed at both sides of the brazing surface, and a horizontal width of the diffusion space is in the range of about 0.01 mm to about 2 mm and a depth of the diffusion space is in the range of about 2 mm to about 10 mm.

Moreover, a bonding area of the cell with the filler metal is widened by sloping or rounding at least one of an edge of the cell end surface and an end edge of an inner peripheral surface of the cap.

According to an embodiment, since brazing is performed between an end surface of a cell and a brazing surface of a cap, a brazing process is simplified in comparison with the related art and the amount of filler metal used is decreased. Since the filler metal diffusion space is formed at the side of the brazing surface, the filler metal is melted and fills the filler metal diffusion space during the brazing process, thus, a bonding area between the filler metal and the cap increases. Consequently, a sufficient bonding power between the cap and the cell is ensured with a smaller amount of filler metal than the related art.

Furthermore, since the filler metal diffusion space is positioned at both sides of the brazing surface, the bonding efficiency is further improved. In addition, since the filler metal is diffused into a gap between the outer peripheral surface of the end of the cell and the cap while the metal filler is diffused, it is possible to acquire a higher brazing effect than the related art without providing additional filler metal in the gap like in the related art.

Further, as described above, since the brazing is performed on the outer peripheral surface of the end of the cell by diffusion of the filler metal positioned on the end surface of the cell, a phenomenon in which the filler metal overflows outside of the cap like in the related art is prevented, and the air seal is improved.

Additional aspects and/or advantages of the subject matter disclosed herein will be set forth in part in the description which follows and, in part, will be obvious from the description, or may be learned by practice of the disclosed subject matter.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a schematic view showing a brazing pattern between a cp and a cell in the related art.

FIG. 2 is a perspective view showing a state in which a cap and a cell are separated from each other.

FIG. 3A is a cross-sectional view showing a combination state of a cap and a cell.

FIG. 3B is a partially enlarged cross-sectional view showing the structure of a cap and a combination state of a cell.

FIG. 3C is a cross-sectional perspective view of FIG. 3B.

FIGS. 4A and 4B are schematic views showing modified examples of a shape of a filler metal diffusion space.

FIG. 5 is a partial cross-sectional view showing a filler metal diffusion space formed by removing an edge of the end of a cell.

FIG. 6 is a partial cross-sectional view showing a brazing state by diffusion of filler metal.

FIG. 7 is a process diagram showing a brazing process of a cap and a cell.

FIG. 8 is a diagram illustrating an embodiment in which filler metal is prevented from overflowing by expanding the area of a minute gap through processing an inner end edge of a combination tube of a cap.

FIG. 9 is a diagram illustrating an embodiment in which a bonding area between filler metal and a cap includes at least one protrusion on an inner surface of a combination tube of the cap.

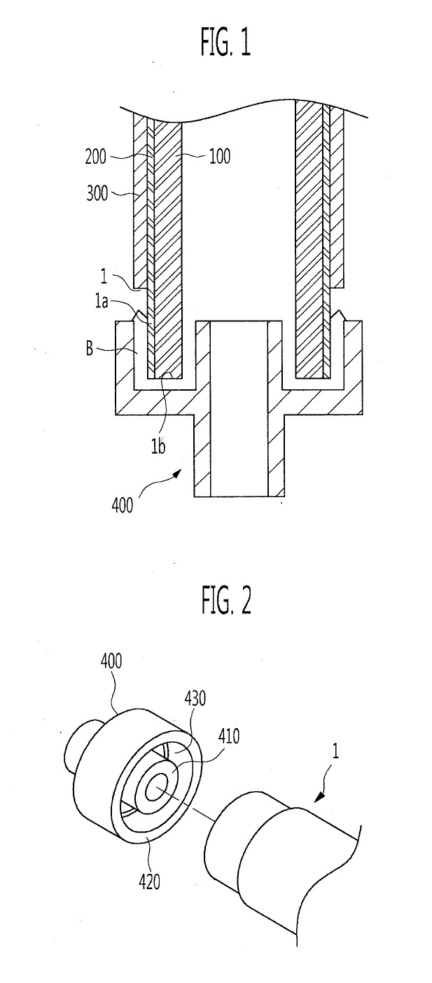

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive.

In addition, when an element is referred to as being “formed on” or “disposed on” another element, it can be formed or disposed directly on the other element or there may be intervening elements between the element and the other element. Also, when an element is referred to as being “connected to” another element, it can be directly connected to the other element or be indirectly connected to the other element with one or more intervening elements interposed therebetween. Hereinafter, like reference numerals refer to like elements.

Reference will now be made in detail to the present embodiments of the present disclosure, examples of which are illustrated in the accompanying drawings, wherein like reference numerals refer to the like elements throughout. The embodiments are described below in order to explain the present disclosure by referring to the figures.

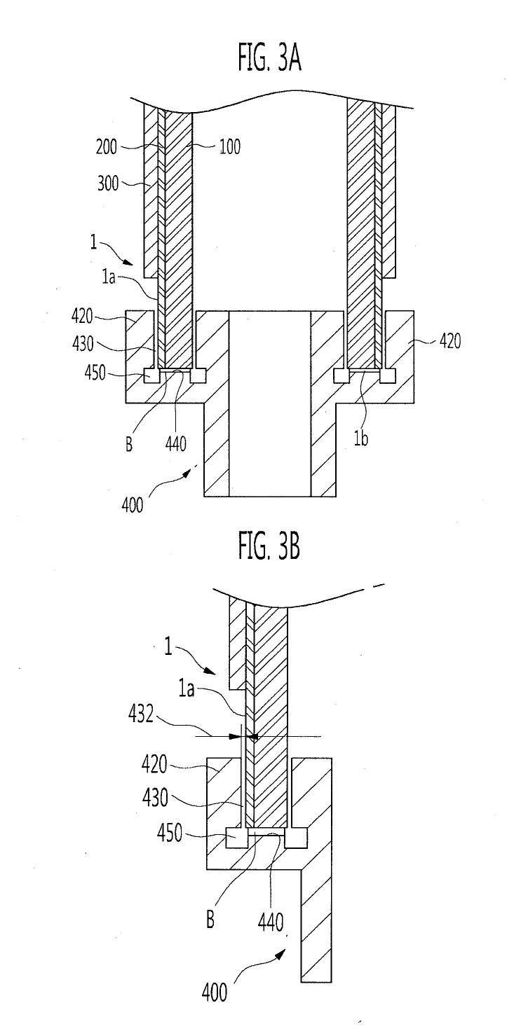

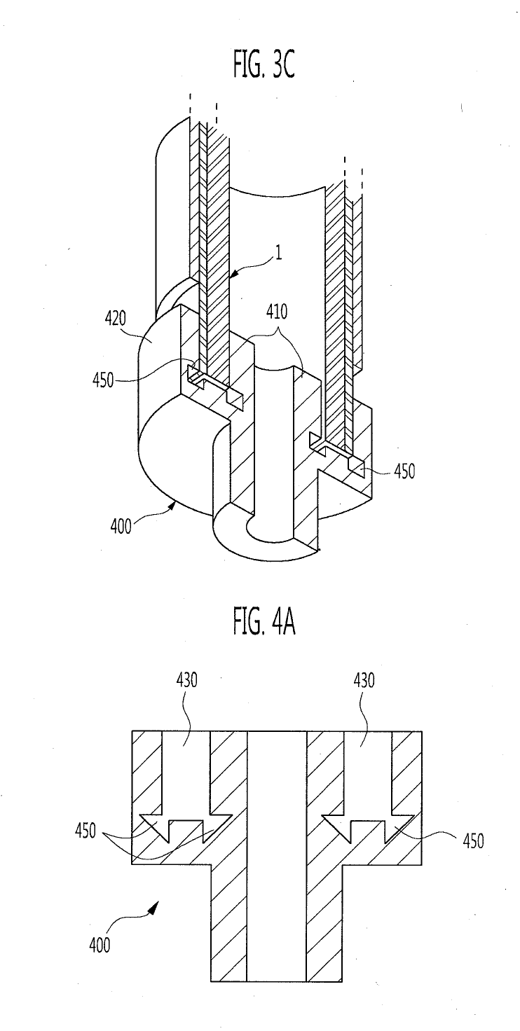

A solid oxide fuel cell of an embodiment of the present disclosure generally includes a cell 1 and a cap 400 as shown in FIGS. 2 and 3A through 3C.

For reference, since other constituent members such as a felt layer or a fixing metallic tube provided in the cell are not related with the core of the aspects of the present disclosure, a detailed description thereof will be omitted.

The cell 1 substantially serves as the cell and herein, the cell 1 includes a first electrode 100 and a second electrode 300 and an electrolyte layer 200.

The first electrode 100 is a cathode to which hydrogen gas is supplied and has a hollow circular shape of which both ends are opened and is made of zirconia (NiO+YSZ) ceramic added with nickel.

The electrolyte layer 200 serving as a movement route of hydrogen ions is provided on an outer peripheral surface of the first electrode 100 and the electrolyte layer 200 is also made of the ceramic such as zirconia and is positioned to surround an entire circumference of the outer peripheral surface of the first electrode 100.

In addition, the second electrode 300 corresponding to an anode is surrounded on the outer peripheral surface of the electrolyte layer 200. The second electrode 300 is not formed on a predetermined section of the end of the electrolyte layer 200 in order to prevent contact with the cap 400 for reasons to be described later.

The cap 400 for preventing supplied fuel gas and outside air from being mixed is located at the end of the cell 1, that is, the ends of the first electrode 100 and the electrolyte layer 200.

The cap 400 has a circular plug shape and has a structure in which a passage tube 410 serving as an inflow route of the fuel gas and serving to combine the cell 1 is provided in the center of the cap 400 and a combination tube 420 surrounds an external circumference of the passage tube 410.

The passage tube 410 and the combination tube 420 are spaced from each other by a predetermined gap, such that a cell insertion space 430 into which the end of the cell 1, that is, the ends of the first electrode 100 and the electrolyte layer 200 are inserted. The cell insertion space 430 is formed between the passage tube 410 and the combination tube 420 and may have a groove shape.

A horizontal width of the cell insertion space 430, that is, a gap between the passage tube 410 and the combination tube 420, is substantially the same as the thickness of the cell 1. When the cell 1 is inserted as shown in the figure, minute gaps 432 are formed between inner and outer peripheral surfaces of the cell 1 and the passage tube 410 and the combination tube 420, such that the filler metal can be filled in the gap 432 during a brazing process to be described later.

In addition, a brazing surface 440 which is a brazing point protrudes from the bottom of the cell insertion space 420 and a filler metal diffusion space 450 which is a core structure is formed at both sides of the brazing surface 440.

The filler metal diffusion space 450 is formed to ensure a sufficient bonding area between the cell 1 and the cap 400 by inducing diffusion of the filler metal through a capillary phenomenon during the brazing process to be described later and is formed on the inner and outer peripheries of the bottom of the cell insertion space 430 as shown in FIG. 3C.

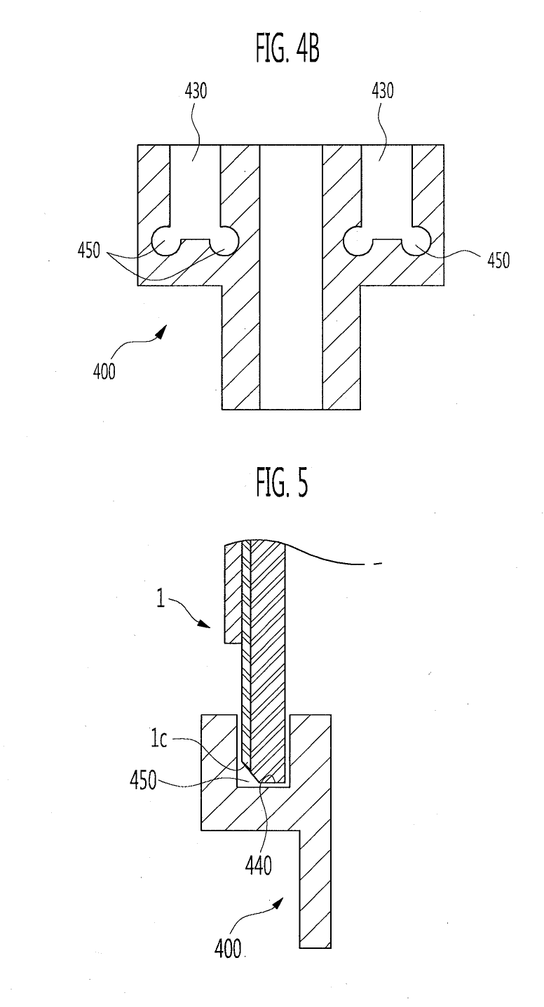

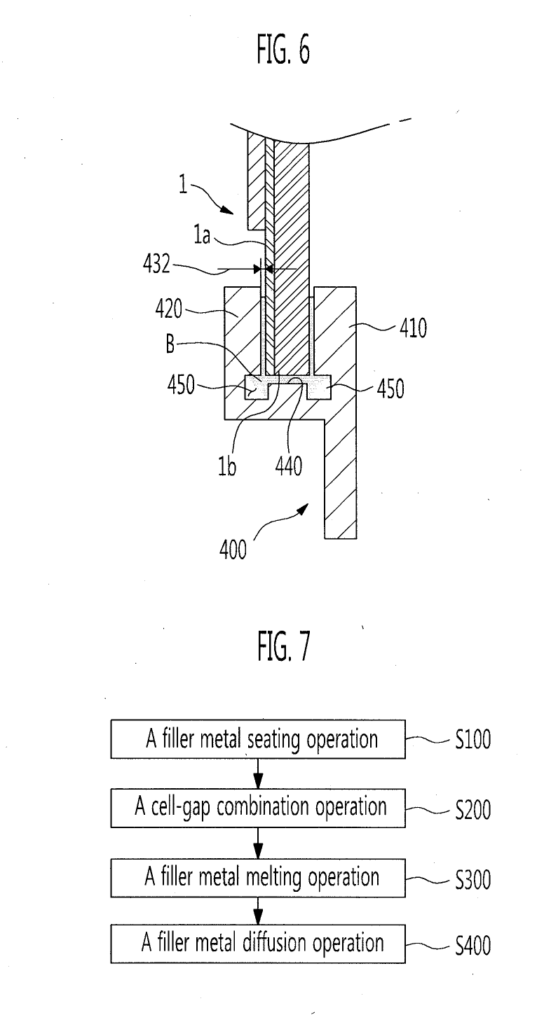

When the filler metal diffusion space 450 is cut in a passage direction of the passage tube 410, a cross section of the filler metal diffusion space 450 may have angular shapes including a triangular shape as shown in FIG. 4A in addition to a rectangular shape shown in FIGS. 3A and 3B.

In order to ensure a better bonding between the boding area and the filler metal, the cross section of the filler metal diffusion space 450 may have other shapes such as a circular shape or an oval shape as shown in FIG. 4B.

Further, although not shown in the figure, brazing efficiency can be achieved using only one diffusion space 450, and therefore the diffusion space 450 may be formed at any one side of the brazing surface 440.

In addition, the brazing efficiency varies depending on the size of the filler metal diffusion space 450 during the brazing process. From several test results, when the horizontal width W of the filler metal diffusion space 450 is in the range of about 0.01 mm to about 2 mm and a longitudinal height H of the filler metal diffusion space 450 is in the range of about 2 mm to about 10 mm, a better boding area is formed.

However, the size of the filler metal diffusion space 450 is not necessarily limited thereto and may vary depending on the sizes of the cell 1 and the cap 400.

Moreover, a method of forming the filler metal diffusion space 450 may be performed in various forms. First, as described above, the filler metal diffusion space 450 may be formed by processing a bottom edge of the cell insertion space 430 in a corresponding shape.

In addition, as shown in FIG. 5, a processing surface 1c having a predetermined slope is formed by processing the edge of the end surface 1b of the cell 1 in a chamfer shape, such that the filler metal diffusion space 450 may naturally be formed between the processing surface 1c and an inner surface of the cell insertion space 430.

Also, when the edge of the cell 1 has a slope because it has been grinded, since the bonding area between the cell end surface 1b and the brazing surface 440 decreases, the filler metal diffusion space 450 is preferably formed at only one side.

The filler metal diffusion space 450 may be formed at both sides when the cell is thick depending on the cell type.

In addition, filler metal used during the brazing process to be described later adopts BNI-2-based or BNI-4-based type containing nickel, chrome, and silicon and the melting point of the filler metal is approximately 450° C.

Hereinafter, the brazing process of an aspect of the present disclosure by the configuration and peculiar effects generated during the process will be described.

For reference, a basic brazing process and basic components such as an induction coil or an induction heating element to be described below use some features of the related art and therefore, a detailed description thereof will be omitted.

First, while the filler metal B, which is a brazing material, is positioned on the brazing surface 440 as shown in FIGS. 3A and 3B, the end of the cell 1 is inserted into the cell insertion space 430 to seat the end surface 1b of the cell 1 on the filler metal B.

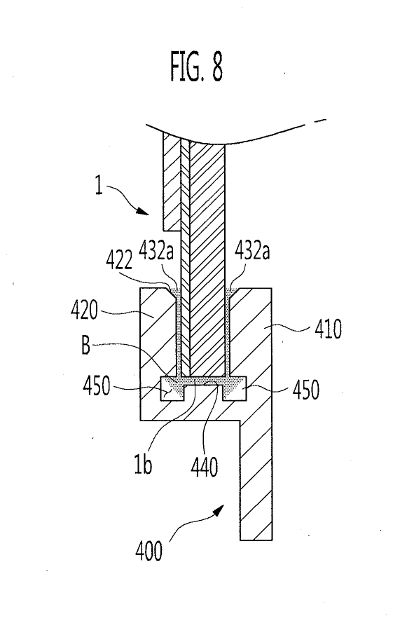

In this state, when a combination of the cell 1 and the cap 400 is put in an additional induction heating furnace (not shown) and heated, the filler metal B is melted and diffused to the whole filler metal diffusion space 450 by the capillary phenomenon as shown in FIG. 6.

Accordingly, when the filler metal coagulates, the end surface of the cell 1 and the brazing surface 440 are basically bonded to each other and during the coagulation, the filler metal is bonded to the entire inner surface of the filler metal diffusion space 450. Consequently, the bonding area between the cell 1 and the cap 400 increases.

Therefore, bonding efficiency similar to the one of the related art can be achieved using a smaller amount of the filler metal.

As such, while the filler metal B is diffused into the diffusion space 450, the filler metal B is also diffused and filled to the minute gaps 432 between the cell 1 and the passage tube 410 and the combination tube 420 by the capillary phenomenon.

Accordingly, unlike the related art in which the filler metal is additionally provided at the corresponding point for brazing between the outer peripheral surface of the cell and the inner peripheral surface of the cap combination tube, the same brazing pattern as the related art is sufficiently implemented with only the filler metal W positioned on the cell end surface 1b.

Furthermore, as the brazing between the diffusion space 450 and the minute gap 432 is performed by using the diffusion generated through one filler metal, the filler metal does not overflow outside the cap due to excessive use of the filler metal like in the related art, thereby preventing the air seal from being deteriorated.

The brazing method of certain embodiments of the present disclosure will be described below.

As shown in FIG. 7, a filler metal seating operation (S100) of positioning the filler metal on the brazing surface of the cap is first performed, a cell-gap combination operation (S200) of contacting the cell end surface onto the filler metal by combining the cell and the cap is performed, a filler metal melting operation (S300) of melting the filler metal through heating is performed, and a filler metal diffusion operation (S400) at which the melted filler metal is diffused into the diffusion space and the minute gap and filled is performed.

In some embodiments, as the diffusion of the filler metal is induced during the brazing by artificially forming the diffusion space of the filler metal in the cell insertion space of the cap, higher brazing efficiency in comparison to the related art can be achieved with a smaller amount of the filler metal and the air seal can be prevented from being deteriorated due to the overflow of the filler metal.

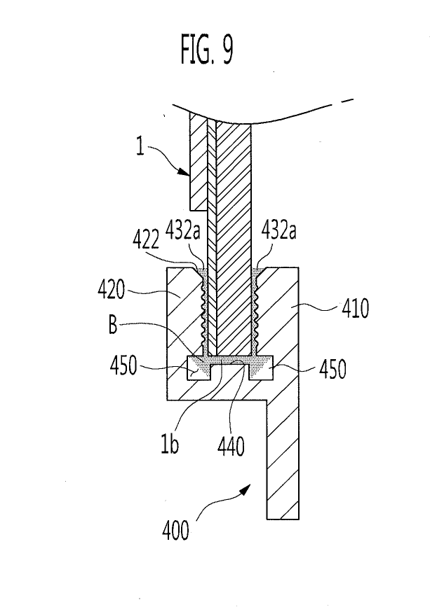

Moreover, FIGS. 8 and 9 are diagrams illustrating a modified example for preventing filler metal diffused into the minute gap 432 from overflowing and increasing the bonding area between the cap 400 and the filler metal.

First, FIG. 8 is an embodiment for preventing the filler metal B from overflowing. Herein, by chamfering or rounding the end of the combination tube 420 of the cap 400, that is, an inner edge of an inlet through which the cell 1 is inserted, the area of the minute gap between the processing surface 422 and the cell 1 is expanded due to an angular change of the processing surface 422.

Accordingly, the filler metal B rises up to the end of the combination tube 420 in the minute gap and thereafter, while the filler metal B fills an expansion gap 432a, the filler metal B is suppressed from rising, thereby preventing the filler metal B from overflowing outside the cap 400.

In addition, FIG. 9 is a modified example for increasing the bonding area between the cap and the filler metal. Herein, a distribution area of the filler metal B is widened in comparison with a flat surface by forming a series of indentations or grooves along the inner peripheral surface of the combination tube 420, thereby improving the bonding force between the cap and the filler metal.

Although a few embodiments have been shown and described, it would be appreciated by those skilled in the art that changes may be made in this embodiment without departing from the principles and spirit of the disclosure, the scope of which is defined in the claims and their equivalents.

What is claimed is:

1. A solid oxide fuel cell including a hollow tube type cell and a sealing cap adjacent to an end of the hollow tube type cell, wherein:
the sealing cap has a structure including a passage tube, positioned within a hollow portion of the hollow tube type cell, provided in a center of the sealing cap, and a combination tube adjacent to an outer peripheral surface of the hollow tube type cell and which is integrally provided on an outer circumference of the passage tube to form a hollow tube type cell insertion space between the passage tube and the combination tube, and
a brazing surface formed on a bottom of the hollow tube type cell insertion space and
a filler metal diffusion space formed at a side of the brazing surface.

2. The solid oxide fuel cell of claim 1, wherein a filler metal is provided between the brazing surface and the hollow tube type cell end surface, and the filler metal is melted when heated beyond a predetermined temperature and fills the filler metal diffusion space.

3. The solid oxide fuel cell of claim 2, wherein the filler metal includes a BIN-based material.

4. The solid oxide fuel cell of claim 2, wherein a gap is formed between the outer peripheral surface of the hollow tube type cell and the combination tube of the sealing cap and the filler metal fills the gap when heated.

5. The solid oxide fuel cell of claim 4, wherein a cross section of the filler metal diffusion space has an angular shape.

6. The solid oxide fuel cell of claim 4, wherein a cross section of the filler metal diffusion space has a circular shape or an oval shape.

7. The solid oxide fuel cell of claim 1, wherein the filler metal diffusion space is formed at both sides of the brazing surface.

8. The solid oxide fuel cell of claim 1, wherein a horizontal width of the filler metal diffusion space is in the range of about 0.01 mm to about 2 mm and a depth of the filler metal diffusion space is in the range of about 2 mm to about 10 mm.

9. The solid oxide fuel cell of claim 1, further comprising a round-type processing surface formed at an edge of the end surface of the hollow tube type cell.

10. The solid oxide fuel cell of claim 7, wherein the round-type processing surface is formed on an end edge of the inner surface of the combination tube of the sealing cap, and an expansion gap is formed between the round-type processing surface and the outer peripheral surface of the sealing cell.

11. The solid oxide fuel cell of claim 1, wherein a protrusion is formed on the inner surface of the combination tube of the sealing cap.

12. A solid oxide fuel cell, comprising:
a hollow tube type cell; and
a sealing cap having a cylindrical shape, the sealing cap including:
a passage tube provided in a center of the sealing cap;
a combination tube formed on an outer circumference of an upper portion of the passage tube and separated from the passage tube by a predetermined distance forming a hollow tube type cell insertion space;
a brazing surface formed between the passage tube and the combination tube on which an end surface of the hollow tube type cell comes into contact; and
a filler metal diffusion space formed at least one side of the brazing surface.

13. The solid oxide fuel cell of claim 13, wherein a gap is formed between the outer peripheral surface of the hollow tube type cell and the combination tube of the sealing cap and the gap is filled with a filler metal.

14. The solid oxide fuel cell of claim 14, wherein the filler metal melts when heated beyond a predetermined temperature.

15. The solid oxide fuel cell of claim 15, wherein the filler metal includes a BIN-based material.

16. The solid oxide fuel cell of claim 13, wherein a cross section of the filler metal diffusion space has an angular shape.

17. The solid oxide fuel cell of claim 13, wherein a cross section of the filler metal diffusion space has a circular shape or an oval shape.

18. The solid oxide fuel cell of claim 13, wherein at least one protrusion is formed on an inner surface of the combination tube of the sealing cap.
